(19) United States
(12) Patent Application Publication
(10) Pub. No.: US 2001/0045293 A1
(43) Pub. Date: Nov. 29, 2001

(54) Weed removal tool

(76) Inventor: Edwin M. Tam, Fincastle, VA (US)

Correspondence Address: Edwin M. Tam, 939 Brughs Mill Road, Fincastle, VA, 24090, US

(21) Appl. No.: 09/851,929

(22) Filed: May 10, 2001

Related U.S. Application Data
(60) Provisional application No. 60/220,287, filed on Jul. 24, 2000.
(60) Provisional application No. 60/206,895, filed on May 25, 2000.

(51) Int. Cl. A01B 1/00

(52) U.S. Cl. 172/378

(57) ABSTRACT

A weed removal tool including an extendible telescoping handle, a multi-postion combination footstep fulcrum, a curved axial leverage member and a deep V-notched tool blade. The device is used to remove unwanted vegetation from a standing position without having to bend over. The operator applies downward Foot pressure to the footstep fulcrum until it engages the ground whereafter the handle is moved rearwardly to uproot and remove the weed.

### CROSS REFERENCE TO RELATED APPLICATIONS

1. Provisional application No. 60/220,287 Jul. 24, 2000 Edwin M. Tam

2. Provisional application No. 60/206,895 May 25, 2000 Edwin M. Tam

### BACKGROUND OF INVENTION

This invention relates to lawn and garden tools and more particular to a manually operated plant or weed extractor.

### DESCRIPTION OF PRIOR ART

Various types of tools have been used to remove unwanted vegetation from lawns and gardens as have a variety of chemical herbicides. Many mechanical weed removal devices are used in the knelling position making the task of weed extraction difficult and troublesome. Many chemical herbicides are deemed by cautious homeowners to be of potentially dangerous chemical compounds in respect to the well being of children and pets as well as a potential threat to ground water contamination. This danger can exist not only during and after applications but also in the home storage phase of the chemicals. Some mechanical weed removal devices are designed to be operated from a standing position, but often include unnecessarily complicated mechanisms, or operate properly only in loose sandy soil, or require two handed operations.

What is needed is a simple and convenient method of manual weed removal, that is easy to use in a standing position, durable, equally efficient in loose sandy soils or rugged difficult clay based soils and can be operated with one hand. In addition the tool should require a minimal amount of shelf storage space at home and in retail locations and be convenient to transport. In this respect, this invention substantially fulfills this need.

### REFERENCES CITED

U.S. Patent Documents

U.S. Pat. No. 5,743,340 April 1998 Giacomini 172/371

It is known to provide a weed pulling apparatus comprising an upright leveraging arm and a ground engaging leveraging arm wherein the upright leveraging arm has a pair of rotating jaw pivots operatively connected to the lower end thereof for gripping the above ground stalk of vegetation therebetween and wherein the ground engaging leveraging arm comprises a fulcrum.

U.S. Pat. No. 5,609,325 March 1997 DeArmond 254/132

It is known to provide an elongated handle with an extended straight shaft to which a (foot) step member is fastened directly to the straight shaft. The current design also utilizes a separate arcuate leverage member connected to said straight shaft and a conventional sharpened forked blade at the said straight shaft open end.

The current tool and handle design does not consider nor utilize an extendible telescoping leverage handle as the new present invention does.

In addition, the current design said step member is fastened directly to the handle extension straight shaft and said step member is not removed away from the elongated leverage handle and the axially extended straight shaft by means of a footstep extension as is utilized in the new present invention.

The new said footstep extension incorporated in the present invention allows the operator to select multiple locations in which to apply foot down force pressure including, left side or right side locations relative to the elongated handle, and now in addition, a new central location can be conveniently selected as well as any simultaneous combination of all said central and side locations. This arrangement for optional foot down force pressure selection does not limit said down force pressure to be applied in an unbalanced fashion to only singularly one side of the elongated handle as in the current design.

Additionally, said footstep extension inn conjunction with its transverse footstep member now creates the new combination Footstep fulcrum in the present invention which completely eliminates any and all separate arcuate leverage members found in the current design and in other conventional fulcrum based mechanical advantage leveraged designs. This new combination footstep fulcrum creates a unique style fulcrum pivot point in which the tool rotates about the footstep fulcrum directly and requires no additional and separate ground contact leverage members common lo the current design and common to the current art of weed removal tools.

In addition, it is known the current design utilizes a straight leverage shaft axially extended from its elongated handle. The design of the present invention has a new improved curved leverage shaft axially extended from the elongated telescoping leverage handle which not only provides for the attachment of the said footstep extension, but also vastly Improves operator line of sight and stance in relation to the plant to be removed. This new curved leverage shaft greatly assists and guides the tool blade forward and under the plant to be removed, as well it enhances the field of motion necessary to mechanically position and operate the elongated telescoping handle in the process of removing unwanted vegetation.

Also it is known the conventional forked blade terminal end of said straight shaft in the current design is of a traditional shape and design. The present invention employs a new deep V-notched design incorporating elongated parallel fingers with squared-off leading edges which serve to guide and enhance the engagement characteristics of the unwanted plants tap root and/or root ball.

U.S. Pat. No. 6,056,068 May 2000 O'Callaghan 172/378

It is known to provide a fulcrum based weed removal device having a separate operator provided leverage pole, and does not contain a telescoping elongated leverage member.. The current design also incorporates an arcuate ground contact rocking base member which has been eliminated by virtue of said combination footstep fulcrum and footstep extension found on the new invention.

U.S. Pat. No. 5,964,451 October 1999 Sudheimer 254/132

It is known that this design covers an egg shaped ergonomic pressure handle grip attached to a conventional straight shaft weed removal apparatus.

U.S. Pat. No. 3,865,348 Jan. 28, 1974 Close 254/132

It is known as a simple straight handle weed puller with a separate arcuate band ground contact member including a terminal end forked blade.

U.S. Pat. No. 5,234,241 August 1993 Ikerd 294/50.8

It is known to be a weed remover consisting of pivotable spikes attached to an elongated tee-handle with attached footstep member.

U.S. Pat. No. 5,383,523 January 1995 Stamp 172/378

It is known to be a weeding tool consisting of a plurality of parallel tines or spikes with a straight handle and elliptically curved body.

U.S. Pat. No. 6,016,876 January 2000 Roundtree 172/378

It is known to be a weed extractor having a handle and a plurality of pivotally mounted opposing spikes.

U.S. Pat. No. 3,976,282 August 1976 Baker 254/132

It is known as a plant root extraction tool having a straight handle with axially extended straight shaft with traditional sharpened fork at the terminal end, utilizing a round shaped rocking base member to obtain a leverage ground contact fulcrum.

U.S. Pat. No. 5,377,374 February 1995 Green 254/132

It is known as a weed extraction device consisting of an elongated rod formed into a grip handle at the upper end, with an integral rod formed footstep and a cutting blade attached at the lower terminal end.

U.S. Pat. No. 4,281,866 August 1979 Atcheson 294/50.5

It is known as a weed puller with ejector device which uses an arcuate leverage ground contact band with Integral footstep attached to a straight handle including a separate ejector rod device to dislodge weeds from a terminal fork.

U.S. Pat. No. 5,060,997 October 1991 Plecki 294/50.6

It is known to be a weed removing device with a tee-handle shaft and blade end.

U.S. Pat. No. 5,456,449 October 1995 Smith 254/50.6

It is known to be a weed removal tool having a pair of upright handles pivotally attached to each other with protruding tapered tines extending from the lower ends of the handles.

### BRIEF SUMMARY OF THE INVENTION

In view of the foregoing disadvantages inherent to the known types of weed removing garden tools and herbicides, this present invention provides a simple method of efficient weed and weed root removal equally effective in loose sandy soils, or difficult clay based soils. The operator of this tool can comfortably stand and remove undesirable weeds and vegetation from lawn and garden with the ease of one handed operation assisted by the power of one foot, down force pressure.

A new style of combination footstep fulcrum has been incorporated into the design of this invention which improves foot to tool contact, as well as completely eliminates the need for an additional and separate arcuate leverage ground contact member that exist in current prior art designs that utilize a fulcrum mechanical advantage principle. This device also introduces to the art of manual weed removal, and is the first to utilize, an elongated telescoping leverage handle used in mechanical advantage fulcrum based manual weed removal.

A new curved leverage shaft extends axially from the elongated telescoping handle and improves tool effectiveness with respect to operator stance and line of sight and assist in locating the tool forward and under the plant to be removed.

This rugged versatile tool of innovative design is replete with numerous modern and upgrade design advantages and principles while eliminating many disadvantages found in the current art of mechanical weed extraction.

To attain this, the present invention essentially comprises an elongated telescoping leverage handle with vinyl hand grip, which is axially extended to the too, blade though the use of a curved leverage member shaft to which a combination footstep fulcrum is extended away from and set transverse to the elongated telescoping handle. By placing the tool adjacent to the plant to be removed, the operator applies foot down force pressure to the combination footstep fulcrum which in turn forces the tool blade and curved leverage shaft into the soil. As the tool is inserted into the soil, the operator guides the tool blade forward and under the plants root ball or tap root using the elongated telescoping handle in conjunction with applied foot pressure. Once inserted into the soil, the combination footstep fulcrum portion of the tool engages the ground at which time the combination footstep fulcrum acquires a new mechanical property in that it becomes the pivot point of a mechanical advantage fulcrum.

This combination footstep fulcrum creates the mechanical advantage in conjunction with the footstep extension, tool blade, curved leverage shaft, and elongated telescoping handle.

By manually pivoting the telescoping handle in a rearward motion, the tool rotates about the footstep fulcrum, as the curved leverage shaft and the tool blade easily lift and uproot the undesirable plant and plant root structure.

This is a broad description of the invention, additional features will follow in detail. The terminology used to describe the invention should not be regarded as limiting as the invention is capable of additional embodiments. Therefore the descriptions are considered illustrative only of the principles of the invention. Since numerous modifications and changes will readily occur to those skilled in the art, it is not desired to limit the invention to the exact construction and operation shown and described, and all suitable modifications and equivalents may be resorted to, falling within the scope of the invention.

### BRIEF DESCRIPTION OF DRAWINGS

The invention will be better understood when the descriptions referred to are used in conjunction with the following drawings.

FIG. 1 is a perspective drawing of the weed removal tool comprising the present invention.

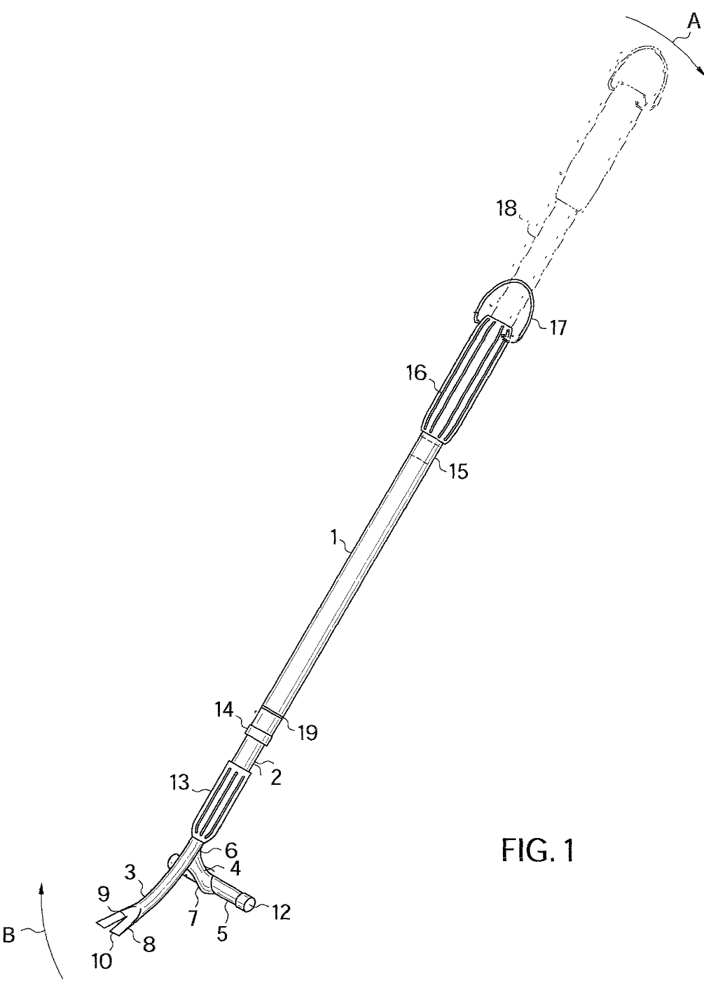

Parts Legend (page 19 of 19) references each part number in FIG. 1 by name.

### DETAILED DESCRIPTION OF THE INVENTION

The present invention will be described;

With reference to FIG. 1, it can be noted that the weed removal tool is composed of an extendible elongated telescoping handle with an upper handle tube designated by numeral 1, and a lower handle tube 2. Upper handle tube 1 and lower handle tube 2 are preferably hollow metal tubes or hollow fiberglass tubes), with tube 1 having a top most upper hand grip 16 and hanging ring 17, and tube 2 having a lower ferrule grip 13. Lower handle tube 2 extends axially from the bottom most open end of tube 1 (opposite the hand grip 16 ) and being of smaller diameter can be inserted into or withdrawn from upper handle tube 1. A conventional commercially available ¼ turn cam-lock 15 is inserted into and mechanically staked to the inside diameter of the upper most open end in tube 2. After sliding the extendible handle to a desired length, a quarter-turn rotation in opposite directions between tube I and tube 2 causes the expansion of the ¼ turn cam-lock 15, locking into position the location of tube 1 relative to the position of tube 2. A stop detent ring 19 is impressed around the circumference of the lower end of tube 1 to prevent the separation of tube 1 from tube 2 upon full handle extension and subsequent engagement of the stop detent ring 19 with the staked ¼ turn cam-lock 15. A vinyl tube guide 14 centers tube 2 and tube 1 allowing tube 2 to slide into and out of tube 1 without metal to metal contact between tubes 1 and 2.

With continued reference to FIG. 1 It can be noted that curved leverage shaft 3 (preferably a solid steel rod) extends axially from and is molded to ferrule grip 13. This curved leverage shaft 3 has its upper most end inserted into and held secure by the molded ferrule grip 13, and it's lower most end is flattened and cut and formed into the shape of the tool blade 8. Tool blade 8 includes an unconventional deep-V-notch 9 which includes two elongated parallel fingers terminating with squared off leading edges 10, which in conjunction with curved leverage shaft 3 improves tool to root and/or tool to root ball contact and engagement. The deep-V-notch 9 is cut approximately 1.5 inches in length and approximately 1.25 inch in width at the outside dimension squared off leading edge 10.

With continued reference to FIG. 1 it can be noted that footstep extension 4 extends nearly perpendicular from curved shaft 3. Footstep extension 4 is preferably hollow steel tubing which is partially flattened and elongated at the inward connecting end and is attached and preferably welded longitudinally along curved shaft 3. The outward terminal end of footstep extension 4 is and flattened 90 degrees in relation to the inward partially flattened end of the extension 4 and wraps under and partially around footstep fulcrum 5. Footstep fulcrum 5 is preferably hollow metal tubing with capped ends 12 and is attached preferably welded to the flattened outward end of footstep extension 4 and positioned transverse to curved shaft 3 and telescoping handle 1 and 2.

The manner of operation of this invention will now be described;

Referring to FIG. 1 the operator grasps the device by upper hand grip 16 and lower ferrule grip 13 and rotates upper hand grip 16 in a counter-clockwise direction while holding lower ferrule grip 13 firmly in place. This motion releases the ¼ turn cam-lock at which time the lower handle tube 2 can be extended away from the upper handle tube 1. Now the two handle tubes 1 and 2 are rotated in the opposite direction to expand and bind the ¼ turn cam-lock into a position which secures the telescoping handle at the desired length for normal operation. Next, holding the weed removal tool in a upright position, the tool blade 8 is placed adjacent to the weed to be removed, foot down force pressure is applied to footstep fulcrum 5 which causes the tool blade 8 and curved leverage shaft 3 to penetrate the soil and move forward and under the plants root ball and/or taproot. As tool blade 8 is guided under the plant the footstep fulcrum 5 comes into ground contact and now becomes a mechanical advantage fulcrum in conjunction with the telescoping handle I and 2 and the curved leverage shaft 3. Once the footstep fulcrum is in ground contact, the telescoping handle I and 2 can be pivoted rearward (FIG. 1 motion A ) which in turn causes the tool to rotate about the footstep fulcrum 5 causing the curved leverage shaft 3 to lift and uproot the undesirable plant and root system (FIG. 1 motion B). Upon completion of the weeding task, the ¼ turn cam-lock 15 is released, the telescoping handle tube 2 is retracted into telescoping handle tube 1, and the tool is stored.

1. A gardening tool comprising a deep V-notched blade, a curved leverage shaft, an elongated handle and a combination footstep fulcrum wherein said curved leverage shaft extends axially away from said deep V-notched blade and said combination footstep fulcrum extends transverse said curved leverage shaft adjacent a terminal end of said curved leverage shaft disposed opposite said deep V-notched blade.

2. A gardening tool as in claim 1 wherein said combination footstep fulcrum is connected to said curved leverage shaft by a footstep extension.

3. A gardening tool as in claim 2 wherein said combination footstep fulcrum is connected transverse said footstep extension adjacent a terminal end thereof.

4. A gardening tool as in claim 1 wherein said combination footstep fulcrum forms the pivot point of a fulcrum in conjunction with ground contact, eliminating the need for a separate arcuate leverage member.

5. A gardening tool as in claim I wherein said footstep fulcrum allows foot down force pressure to be applied to the left side, right side, center or any combination of said foot down force pressure locations relative to the said curved leverage shaft and said elongated handle.

6. A gardening tool as in claim 1 wherein said curved leverage shaft is affixed to said elongated handle at the terminal end of said curved leverage shaft.

7. A gardening tool as in claim 1 wherein said elongated handle comprises extendible telescoping members.

8. A gardening tool as in claim 7 wherein one of said telescoping members is affixed to said terminal end of said curved leverage shaft.

9. A gardening tool as in claim 7 wherein another of said telescoping members has a hand grip member affixed to an open end thereof.

10. A gardening tool as in claim 1 wherein said elongated handle member is alternatively a fixed non-telescoping member.

11. A gardening tool as in claim 1 wherein said deep V-notched blade has been elongated and widened and includes two nearly parallel fingers with squared off leading edges to enhance root-ball and or tap root engagement characteristics.

12. A gardening tool as in claim 1 wherein said deep V-notched blade is formed, cut and integral to said curved leverage shaft member.

13. A gardening tool as in claim 1 wherein said blade is alternatively attached to said shaft as a separate non-integral member

14. A gardening tool as in claim 1 wherein said curved leverage shaft and said deep V-notched blade are fabricated from a solid metal bar.

15. A gardening tool as in claim 1 wherein said curved leverage shaft and said deep V-notched blade are alternatively fabricated from a hollow metal tube.

16. A gardening tool as in claim I wherein said elongated handle is fabricated from hollow metal tubing.

17. A gardening tool as in claim I wherein said elongated handle is telescoping and is fabricated from hollow fiberglass tubing, plastic, vinyl, composite material, or solid metal designed to resist imposed loading.

18. A gardening tool as in claim 1 wherein said elongated handle is telescoping and the down force necessary to penetrate the soil is alternatively applied by hand through the telescoping elongated handle.

19. A method of making a gardening tool comprising the steps of forming deep V-notched blade, a curved leverage shaft, an elongated handle and a combination footstep fulcrum wherein said step of forming said curved leverage shaft and said deep V-notched blade comprises the steps of axially disposing said deep V-notched blade at one end of an elongated shaft and said curved leverage shaft on an opposite end of said elongated shaft, flattening said one end of said elongated shaft, cutting said deep V-notched blade into said flattened end, shaping a terminal end of each parallel tongue of said flattened end, joining said combination footstep fulcrum to said curved leverage shaft spaced inwardly from a free end thereof and joining said elongated handle to said free end of said curved leverage shaft.

20. A method of using a gardening tool for removing unwanted vegetation, said gardening tool comprising a deep V-notched blade, a curved leverage shaft, an elongated handle and a combination footstep fulcrum having means for engaging a foot of an operator thereon wherein said operator grasps an open end of said elongated handle in one hand, positions said deep V-notched blade adjacent said unwanted vegetation, engages said footstep fulcrum with one foot, applies downward pressure to said footstep fulcrum with said foot thereby thrusting said deep V-notched blade under said unwanted vegetation and engaging said footstep fulcrum with the surface adjacent said unwanted vegetation, applying rearward force to said open end of elongated handle thereby lifting said unwanted vegetation from said surface.
